(19) United States
(12) Patent Application Publication
(10) Pub. No.: US 2008/0057300 A1
(43) Pub. Date: Mar. 6, 2008

(54) Protective Film Wear Layer

(75) Inventors: Adriana Paiva, Woodbury, MN (US); Susan K. Yarmey, Woodbury, MN (US); Stefan H. Gryska, Woodbury, MN (US); Michael C. Palazzotto, Woodbury, MN (US); Sharon Wang, St. Paul, MN (US); Jeffery T. Anderson, Lake Elmo, MN (US); Gerald R.A. Hofmann, Oakdale, MN (US); Wendy L. Thompson, Roseville, MN (US); John T. Brady, Lino Lakes, MN (US); William J. Schultz, North Oaks, MN (US); Robert M. Jennings, Shoreview, MN (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, ST. PAUL, MN (US)

(21) Appl. No.: 11/576,951

(22) PCT Filed: Oct. 12, 2005
(86) PCT No.: PCT/US05/36517

§ 371 Date: Apr. 10, 2007

Related U.S. Application Data
(60) Provisional application No. 60/617,951, filed on Oct. 12, 2004.

(51) Int. Cl. C08K 9/04; B32B 27/20

(52) U.S. Cl. 428/336; 427/385.5

(57) ABSTRACT

A protective floor film includes a base film layer and a U.V. cured wear layer disposed on the base film layer. The wear layer has a thickness in a range of 2 to 25 micrometers. Methods of making protective floor film and methods of protecting a floor are also disclosed.

### BACKGROUND

The present invention relates generally to a protective film wear layer. More particularly, the present invention relates to a protective floor film wear layer.

Floor care programs today are primarily used to both protect and/or enhance the appearance of a floor substrate, such as vinyl, marble, terrazzo, ceramic, linoleum, wood, etc. floor substrates. Floor care programs can include many different types of products, but generally involve the use of a sealer and/or finish applied to the surface of the floor substrate. This finish can be maintained with the use of cleaners and tools, which can include various buffing or burnishing machines. Although these programs are effective, they are considered a large expense to customers. Additionally, if a surface becomes worn or unsatisfactory over time, it is necessary to entirely remove the floor substrate, to provide a new fresher look to the floor.

Polymer-based floor coatings are an example of finishes that are typically applied as an aqueous emulsion or solvent solution that dries to a hard film. After months of exposure to traffic, such finishes become scratched, scuffed and soiled to a point where they need to be completely removed from the floor and a new finish applied. The removal of these coatings from floors has traditionally required the use of chemical solutions, typically mixtures of alkalis and volatile solvents. These chemical mixtures can be generally unpleasant and messy to use. In addition, some highly cross-linked polymer-based floor coatings are difficult, if not impossible to remove by any means other than physical abrasion. Improved floor care programs are desired.

### SUMMARY

Generally, the present invention relates to protective film including a wear layer. More particularly, the present invention relates to a protective floor film wear layer.

In one embodiment, a protective floor film includes a base film layer and a U.V. cured wear layer disposed on the base film layer. The wear layer has a thickness in a range of 2 to 25 micrometers.

In another embodiment, a method of making protective floor film includes coating a curable wear layer on a base film layer and curing the wear layer to form a cured wear layer having a thickness in a range of 2 to 25 micrometers.

In a further embodiment, a method of protecting a floor includes providing a protective floor film and laminating the protective floor film onto a floor surface. The floor film includes a pressure sensitive adhesive layer, a cured wear layer on a base film layer, and a base film layer disposed between the pressure sensitive adhesive layer and the cured wear layer. The cured wear layer has a thickness in a range form 2 to 25 micrometers.

In a further embodiment, a protective film includes a base film layer and a U.V. cured wear layer disposed on the base film layer. The U.V. cured wear layer includes an epoxy and a plurality of surface modified inorganic particles. The wear layer has a thickness in a range of 2 to 25 micrometers.

In another embodiment, a protective film includes a base film layer and a U.V. cured wear layer disposed on the base film layer. The U.V. cured wear layer includes a plurality of surface modified inorganic particles. The wear layer has a thickness in a range of 2 to 25 micrometers. The wear layer has an elongation to crack value of at least 5% and a taber abrasion % haze change value at 1000 cycles of 30% or less.

In still another embodiment, a protective film includes a base film layer and a U.V. cured wear layer disposed on the base film layer. The U.V. cured wear layer includes a plurality of surface modified inorganic particles. The wear layer has a thickness in a range of 2 to 25 micrometers. The wear layer has an elongation to crack value of at least 10% and a taber abrasion % haze change value at 1000 cycles of 50% or less.

The above summary of the present invention is not intended to describe each disclosed embodiment or every implementation of the present invention. The Figures, Detailed Description and Examples which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a schematic diagram of a protective floor film article.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

For the following defined terms, these definitions shall be applied, unless a different definition is given in the claims or elsewhere in this specification.

The term “polymer” will be understood to include polymers, copolymers (e.g., polymers formed using two or more different monomers), oligomers and combinations thereof, as well as polymers, oligomers, or copolymers that can be formed in a miscible blend.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

Unless otherwise indicated, all numbers expressing quantities of ingredients, measurement of properties such as contrast ratio and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

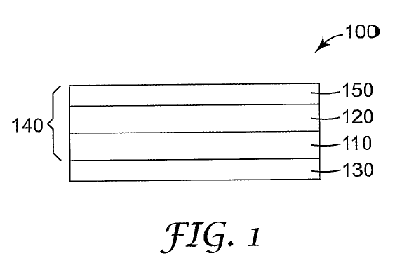

FIG. 1 shows a schematic diagram of one exemplary embodiment of a protective floor film article 140 disposed on a flooring substrate 130. The protective floor film article 140 can include a pressure sensitive adhesive layer 110, a base floor film layer 120 disposed on the pressure sensitive adhesive layer 110, and a cured wear layer 150. The pressure sensitive adhesive layer 110 can be disposed on the flooring substrate 130 to form a protected flooring article 100.

The flooring substrate 130 can be formed from any suitable flooring material. A partial listing of flooring substrates 130 include, for example, vinyl, marble, terrazzo, ceramic, linoleum, wood, metal, plastic, rubber, concrete, stone, vinyl composition tile, and glass.

Although the compositions and methods of the present invention may find use in laminating films to floors, the compositions and methods may also be used to laminate adhesive-backed films to other surfaces such as, e.g., sidewalks, driveways, parking lots, walls, countertops, flooring materials, dry-erase boards, roads, tabletops, whiteboards, windows, shelves, patios, ceilings, stairs, etc.

The flooring substrate 130 can optionally include one or more floor finishes (not shown) disposed between the flooring substrate 130 and the pressure sensitive layer 110. Floor finishes or floor polishes can include a polymer compositions used in their formulation. Commercially available floor finish compositions can be aqueous emulsion-based polymer compositions including one or more organic solvents, plasticizers, coating aides, anti-foaming agents, polymer emulsions, metal complexing agents, waxes, and the like. These floor finish compositions can be applied to a floor surface and then allowed to dry in air, normally at ambient temperature and humidity.

The base film layer 120 may be made from any material suitable for providing a protective layer on an underlying flooring substrate 130. An example of a suitable material for the base film layer 120 is a polymer. In some embodiments, the base film layer 120 includes a polymer. The base film layer 110 can include a transparent polymer such as, for example a transparent polyolefin. Examples of suitable polymer films include, but are not limited to, polypropylene films, polyacetal films, polyamide films, polyester films, polystyrene films, polyvinyl chloride films, polyvinylidene chloride films, polyurethane films, polyurea films, and the like. In one embodiment the polymer film includes a polyethylene terephthalate (PET). In another embodiment the polymer film includes an ionomeric polyolefin blend available under the tradename Surlyn™ (DuPont, Willmington, Del.).

The thickness of the base film layer 120 can be any useful thickness. In some embodiments, the base film layer 120 has a thickness of 25 to 2500 micrometers or 25 to 250 micrometers. In another embodiment, the base film layer 120 has a thickness of 25 to 125 micrometers. In another embodiment, the base film layer 120 has a thickness of 25 to 75 micrometers.

The pressure sensitive adhesive layer 110 can include, an acrylic pressure sensitive adhesive having an inherent viscosity in a range of 0.3 to 2.0 dl/g, a covalent cross-linker, and a plasticizer compatible with the acrylic pressure sensitive adhesive. Acrylic PSAs generally include a primary component of acrylate or methacrylate monomer or a combination of such monomers which, when polymerized, have a low glass transition temperature (Tg) and a low modulus (i.e. they are rubbery and soft). These soft, tacky low Tg monomers are can be copolymerized with a secondary component consisting of high Tg monomers, usually polar monomers such as acrylic acid, methacrylic acid, itaconic acid, acrylamide, methacrylamide, and mixtures thereof. As described in U.S. Pat. No. Re 24,906, when such polar monomers are incorporated with a predominance of low Tg monomers, a sufficiently tacky pressure-sensitive adhesive is formed having high cohesive or internal strength. Further increase in internal or cohesive strength (i.e., shear strength) can be obtained via cross-linking. The pressure sensitive adhesive layer 110 can have any useful thickness. In some embodiments, the pressure sensitive adhesive layer 110 has a thickness of 25 to 75 micrometers, or from 25 to 50 micrometers.

The cured wear layer 150 may be made from any material suitably curable polymeric material. An example of a suitable material for the cured wear layer 150 is a multi-functional or cross-linkable monomer. Illustrative cross-linkable monomers include acrylates, urethane acrylates, and epoxies. In some embodiments, cross-linkable monomers includes mixtures of acrylates, urethane acrylates, or epoxies. In some embodiments, the cured wear layer 150 includes a plurality of inorganic nanoparticles. The inorganic nanoparticles can include, for example, silica, alumina, or zirconia nanoparticles. In some embodiments, the nanoparticles have a mean diameter in a range from 1 to 200 nm, or 5 to 150 nm, or 5 to 125 nm. In illustrative embodiments, the nanoparticles can be “surface modified” such that the nanoparticles provide a stable dispersion in which the nanoparticles do not agglomerate after standing for a period of time, such as 24 hours, under ambient conditions.

The thickness of the cured wear layer resin layer 150 can be any useful thickness. In some embodiments, the cured wear layer resin layer 150 has a thickness of 2 to 25 micrometers. In another embodiment, cured wear layer 150 has a thickness of 2 to 15 micrometers. In another embodiment, cured wear layer 150 has a thickness of 3 to 10 micrometers.

Useful acrylates include, for example, poly (meth)acryl monomers such as, for example, (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as ditrimethylolpropane tetraacrylate, dipentaerythritol pentaacrylate, ethoxylated (4) pentaerythritol tetraacrylate, pentaerythritol tetraacrylate, caprolactone modified dipentaerythritol hexaacrylate; (d) oligomeric (meth)acryl compounds such as, for example, urethane acrylates, polyester acrylates, epoxy acrylates; polyacrylamide analogues of the foregoing such as, for example, N,N-dimethyl acrylamide; and combinations thereof. Such compounds are widely available from vendors such as, for example, Sartomer Company, Exton, Pa.; UCB Chemicals Corporation, Smyrna, Ga.; and Aldrich Chemical Company, Milwaukee, Wis. Additional useful (meth)acrylate materials include hydantoin moiety-containing poly(meth)acrylates, for example, as described in U.S. Pat. No. 4,262,072 (Wendling et al.).

In illustrative embodiment, the curable wear layer includes a monomer having at least three (meth)acrylate functional groups. Commercially available cross-linkable acrylate monomers include those available from Sartomer Company, Exton, Pa. such as trimethylolpropane triacrylate available under the trade designation “SR351”, pentaerythritol triacrylate available under the trade designation “SR444”, dipentaerythritol triacrylate available under the trade designation “SR399LV”, ethoxylated (3) trimethylolpropane triacrylate available under the trade designation “SR454”, ethoxylated (4) pentaerythritol triacrylate, available under the trade designation “SR494”, tris(2-hydroxyethyl)isocyanurate triacrylate, available under the trade designation “SR368”, and dipropylene glycol diacrylate, available under the trade designation “SR508”.

Useful urethane acrylate monomers include, for example, a hexafunctional urethane acrylate available under the tradename Ebecryl 8301 from Radcure UCB Chemicals, Smyrna, Ga. and a difunctional urethane acrylate available under the tradename Ebecryl 8402 from Radcure UCB Chemicals, Smyrna, Ga. A cured wear layer including urethane acrylates can have an elongation to crack value (as described in the Methods section below) of 2% or greater, or 5% or greater, or 10% or greater.

In some embodiments, a protective film includes a base film layer and a U.V. cured wear layer disposed on the base film layer. The U.V. cured wear layer includes a plurality of surface modified inorganic particles. The U.V. cured wear layer includes a urethane acrylate. The wear layer can have an elongation to crack value of at least 5% and a Taber abrasion % haze change value at 1000 cycles of 30% or less, or 15% or less. In other embodiments, the wear layer has an elongation to crack value of at least 10% and a Taber abrasion % haze change value at 1000 cycles of 50% or less, or 30% or less, or 15% or less. Elongation to crack values defined herein are determined by the Elongation to Crack test method set forth in the Methods section below. Taber abrasion % haze change values defined herein are determined by the Taber Abrasion test method set forth in the Methods section below.

A partial listing of useful epoxy monomers include 1,2-, 1,3-, and 1,4-cyclic ethers (also designated as 1,2-, 1,3-, and 1,4-epoxides). See the “Encyclopedia of Polymer Science and Technology”, 6, (1986), p. 322, for a description of suitable epoxy resins. In particular, cyclic ethers that are useful include the cycloaliphatic epoxies such as cyclohexene oxide and the ERL™ and UVR™ series type of resins available from Dow Chemical, Midland, Mich., such as vinylcyclohexene oxide, vinylcyclohexene dioxide, 3,4-epoxycyclohexylmethyl-3,4-epoxycyclohexane carboxylate, bis-(3,4-epoxycyclohexyl)adipate and 2-(3,4-epoxycylclohexyl-5,5-spiro-3,4-epoxy) cyclohexene-meta-dioxane; also included are the glycidyl ether type epoxy resins such as propylene oxide, epichlorohydrin, styrene oxide, glycidol, the Epon™, Eponex™, and Heloxy™ series type of epoxy resins available from Resolution Performance Products, Houston, Tex., including the diglycidyl either of bisphenol A and chain extended versions of this material such as Epon 828, Epon 1001, Epon 1004, Epon 1007, Epon 1009 and Epon 2002 or their equivalent from other manufacturers, Eponex™ 1510, the hydrogenated diglycidyl either of bisphenol A, Heloxy™ 67, diglycidyl ether of 1,4-butanediol, Heloxy™ 107, diglycidyl ether of cyclohexane dimethanol, or their equivalent from other manufacturers, dicyclopentadiene dioxide, epoxidized vegetable oils such as epoxidized linseed and soybean oils available as Vikolox™ and Vikoflex™ resins from Atofina, Philadelphia, Pa., epoxidized Kraton Liquid™ Polymers, such as L-207 available from Kraton Polymers, Houston, Tex., epoxidized polybutadienes such as the Poly BD™ resins from Atofina, Philadelphia, Pa., 1,4-butanediol diglycidyl ether, polyglycidyl ether of phenolformaldehyde, and for example DEN™ epoxidized phenolic novolac resins such as DEN 431 and DEN 438 available from Dow Chemical Co., Midland Mich., epoxidized cresol novolac resins such as Araldite ECN™ 1299 available from Vantico AG, Basel, Switzerland, resorcinol diglycidyl ether, and epoxidized polystyrene/polybutadiene blends such as the Epofriend™ resins such as Epofriend A1010 available from Daicel USA Inc., Fort Lee, N.J., and resorcinol diglycidyl ether.

In some embodiments, preferred epoxy resins include the ERL™ and the UVR™ type of resins especially 3,4-epoxycyclohexylmethyl-3,4-epoxycyclohexanecarboxylate, bis-(3,4-epoxycyclohexyl)adipate and 2-(3,4-epoxycylclohexyl-5,5-s-piro-3,4-epoxy)cyclohexene-meta-dioxane and the bisphenol A Epon™ type resins including 2,2-bis-p-(2,3-epoxypropoxy)phenylpropane and chain extended versions of this material and, resins of the type Eponex™ 1510 and Heloxy™ 107 and 68. Also useful in the present invention are purified versions of these epoxies as described in U.S. published patent application 2002/0022709 published 21 Feb. 2002.

When preparing compositions containing epoxy monomers, hydroxy-functional materials can be added. The hydroxyl-functional component can be present as a mixture material can aid in chain extension and in preventing excess crosslinking of the epoxy during curing, e.g., increasing the toughness of the cured composition.

When present, useful hydroxyl-functional materials include aliphatic, cycloaliphatic or alkanol-substituted arene mono- or poly-alcohols having from about 2 to about 18 carbon atoms and two to five, or from two to four hydroxy groups, or combinations thereof. Useful mono-alcohols can include methanol, ethanol, 1-propanol, 2-propanol, 2-methyl-2-propanol, 1-butanol, 2-butanol, 1-pentanol, neopentyl alcohol, 3-pentanol, 1-hexanol, 1-heptanol, 1-octanol, 2-phenoxyethanol, cyclopentanol, cyclohexanol, cyclohexylmethanol, 3-cyclohexyl-1-propanol, 2-norbornanemethanol and tetrahydrofurfuryl alcohol.

In some embodiments useful polyols include aliphatic, cycloaliphatic, or alkanol-substituted arene polyols, or mixtures thereof having from about 2 to about 18 carbon atoms and two to five, or from two to four hydroxyl groups. Examples of useful polyols include 1,2-ethanediol, 1,2-propanediol, 1,3-propanediol, 1,4-butanediol, 1,3-butanediol, 2-methyl-1,3-propanediol-, 2,2-dimethyl-1,3-propanediol, 2-ethyl-1,6-hexanediol, 1,5-pentanediol, 1,6-hexanediol, 1,8-octanediol, neopentyl glycol, glycerol, trimethylolpropane, 1,2,6-hexanetriol, trimethylolethane, pentaerythritol, quinitol, mannitol, sorbitol, diethylene glycol, triethylene glycol, tetraethylene glycol, glycerine, 2-ethyl-2-(hydroxymethyl)-1,3-propanediol, 2-ethyl-1,3-pentanediol, 1,4-cyclohexanedimethanol, 1,4-benzene-dimethanol and polyalkoxylated bisphenol A derivatives. Other examples of useful polyols are disclosed in U.S. Pat. No. 4,503,211.

Higher molecular weight polyols include the polyethylene and polypropylene oxide polymers in the molecular weight (4) range of 200 to 20,000 such as the Carbowax™ polyethyleneoxide materials available from Dow Chemical Co., Midland, Mich., caprolactone polyols in the molecular weight range of 200 to 5,000 such as the Tone™ polyol materials available from Dow, polytetramethylene ether glycol in the molecular weight range of 200 to 4,000, such as the Terathane™ materials available from DuPont and PolyTHF™ 250 from BASF, polyethylene glycol, such as PEG™ 200 available from Dow, hydroxyl-terminated polybutadiene resins such as the Poly BD materials available from Atofina, Philadelphia, Pa., phenoxy resins such as those commercially available from Phenoxy Associates, Rock Hill, S.C., or equivalent materials supplied by other manufacturers.

In some embodiments, the nanoparticles are inorganic nanoparticles such as, for example, silica, alumina, or zirconia. Silica nanoparticles can be present in an amount from 10 to 200 parts per 100 parts of wear layer monomer. Silicas for use in the materials of the invention are commercially available from Nalco Chemical Co. (Naperville, Ill.) under the product designation NALCO COLLOIDAL SILICAS. For example, silicas include NALCO products 1040, 1042, 1050, 1060, 2327 and 2329. Zirconia nanoparticles are commercially available from Nalco Chemical Co. (Naperville, Ill.) under the product designation NALCO OOSSOO8.

Surface treating or surface modification of the nano-sized particles can provide a stable dispersion in the wear layer resin. The surface-treatment can stabilize the nanoparticles so that the particles will be well dispersed in the polymerizable resin and result in a substantially homogeneous composition. Furthermore, the nanoparticles can be modified over at least a portion of its surface with a surface treatment agent so that the stabilized particle can copolymerize or react with the polymerizable wear layer resin during curing.

The nanoparticles can be treated with a surface treatment agent. In general a surface treatment agent has a first end that will attach to the particle surface (covalently, ionically or through strong physisorption) and a second end that imparts compatibility of the particle with the wear layer resin and/or reacts with wear layer resin during curing. Examples of surface treatment agents include alcohols, amines, carboxylic acids, sulfonic acids, phosphonic acids, silanes and titanates. The preferred type of treatment agent is determined, in part, by the chemical nature of the inorganic particle or metal oxide particle surface. Silanes are generally preferred for silica and zirconia (the term “zirconia” includes zirconia metal oxide). The surface modification c an be done either subsequent to mixing with the monomers or after mixing.

In some embodiment, it is preferred to react silanes with the particle or nanoparticle surface before incorporation into the resin. The required amount of surface modifier is dependant upon several factors such particle size, particle type, modifier molecular wt, and modifier type. In general it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for from 1-24 hr approximately. Surface treatment agents such as carboxylic acids do not require elevated temperatures or extended time.

Surface modification of zirconia (ZrO₂) with silanes can be accomplished under acidic conditions or basic conditions. In one embodiment, silanes are preferably heated under acid conditions for a suitable period of time. At which time the dispersion is combined with aqueous ammonia (or other base). This method allows removal of the acid counter ion from the ZrO₂ surface as well as reaction with the silane. Then the particles are precipitated from the dispersion and separated from the liquid phase. The Example section below describes several non-limiting methods for surface modifying silicas nanoparticles.

The surface modified particles can be incorporated into the curable resin in various methods. In one embodiment, a solvent exchange procedure is utilized whereby the resin is added to the surface modified nanoparticles, followed by removal of the water and co-solvent (if used) via evaporation, thus leaving the particles dispersed in the polymerizable resin. The evaporation step can be accomplished for example, via distillation, rotary evaporation or oven drying, as desired.

Representative embodiments of surface treatment agents suitable for inclusion in the wear layer include compounds such as, for example, phenyltrimethoxysilane, phenyltriethoxysilane, 2-(3,4-epoxycyclohexyl)ethyltriethoxysilane, 2-(3,4-epoxycyclohexyl)ethyltrimethoxysilane, isooctyl trimethoxy-silane, N-(3-triethoxysilylpropyl)methoxyethoxyethoxyethyl carbamate (PEG3TES), Silquest A1230, N-(3-triethoxysilylpropyl)methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, 3-(methacryloyloxy)propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures thereof.

A photoinitiator can be included in the wear layer. Examples of initiators include, organic peroxides, azo compounds, quinines, nitro compounds, acyl halides, hydrazones, mercapto compounds, pyrylium compounds, imidazoles, chlorotriazines, benzoin, benzoin alkyl ethers, di-ketones, phenones, and the like. Commercially available photoinitiators include, but not limited to, those available commercially from Ciba Geigy under the trade designations DARACUR 1173, DAROCUR 4265, IRGACURE 651, IRGACURE 184, IRGACURE 1800, IRGACURE 369, IRGACURE 1700, and IRGACURE 907, IRGACURE 819 and from Aceto Corp., Lake Success N.Y., under the trade designations UVI-6976 and UVI-6992. Phenyl-[p-(2-hydroxytetradecyloxy)phenyl]iodonium hexafluoroantomonate is a photoinitiator commercially available from Gelest, Tullytown, Pa. Phosphine oxide derivatives include LUCIRIN TPO, which is 2,4,6-trimethylbenzoy diphenyl phosphine oxide, available from BASF, Charlotte, N.C. In addition, further useful photoinitiators are described in U.S. Pat. Nos. 4,250,311, 3,708,296, 4,069,055, 4,216,288, 5,084,586, 5,124,417, 5,554,664, and 5,672,637. A photoinitiator can be used at a concentration of about 0.1 to 10 weight percent or about 0.1 to 5 weight percent based on the organic portion of the formulation (phr.)

The protective floor film article can optionally include one or more additional layers (not shown). Additional layers can include, for example, a release liner layer, or a surface treatment layer.

A release liner can optionally be disposed on the pressure sensitive adhesive prior to laminating the protective floor film onto the flooring substrate. Thus, the pressure sensitive adhesive layer can be disposed between the release liner and the base floor film layer. The release liner can be formed of any useful material such as, for example, polymers or paper and may include a release coat. Suitable materials for use in release coats are well known and include, but are not limited to, fluoropolymers, acrylics and silicons designed to facilitate the release of the release liner from the pressure sensitive adhesive. The release coat may be designed to remain substantially adhered to the release liner after the transfer of the film to the surface to be finished.

The surface of the base floor film layer which contacts the pressure sensitive adhesive layer and the cured wear layer can be a wide variety of materials. Therefore, surface treatments may be useful to secure adhesion between the base floor film layer and the acrylic pressure sensitive adhesive layer or the cured wear layer. Surface treatments include, for example, chemical priming, corona treatment, plasma or flame treatment.

A chemical primer layer or a corona treatment layer can be disposed between the base floor film layer 120 and the acrylic pressure sensitive adhesive layer 110. A chemical primer layer or a corona treatment layer can be disposed between the base floor film layer 120 and the cured wear layer 150. When a chemical primer layer and/or corona treatment is employed, inter-layer adhesion between the base floor film layer 120 and the acrylic pressure sensitive adhesive layer 110 and/or cured wear layer, can be improved.

Suitable chemical primer layers may be selected from urethanes, silicones, epoxy resins, vinyl acetate resins, ethylenimines, and the like. Examples of chemical primers for vinyl and polyethylene terephthalate films include crosslinked acrylic ester/acrylic acid copolymers disclosed in U.S. Pat. No. 3,578,622. The thickness of the chemical primer layer is suitably within the range of 10 to 3,000 nanometers (nm).

Corona treatment is a useful physical priming suitably applied to the base floor film layer 120 onto which is then coated the acrylic pressure sensitive adhesive layer 110 and/or the cured wear layer 150. Corona treatment can improve the inter-layer adhesion between the base floor film layer 120 and the acrylic pressure sensitive adhesive layer 110 and/or the cured wear layer 150. Corona treatment of films is a well-known technique, and is described generally in Cramm, R. H., and Bibee, D. V., The Theory and Practice of Corona Treatment for Improving Adhesion, TAPPI, Vol. 65, No. 8, pp 75-78 (August 1982), and in U.S. Defensive publication H 688, published Oct. 3, 1989.

The protective floor film 140 can be laminated onto the flooring substrate 130 at any useful rate. In some embodiments, the protective floor film 140 is laminated onto the flooring substrate 130 at a rate of 0.005 meters per second, or 0.05 meters per second, or 0.5 meters per second.

The protective floor film 140 can be removed from the flooring substrate 130 at any useful rate. In some embodiments, the protective floor film 140 is removed from the flooring substrate 130 at a rate of 0.005 meters per second, or 0.05 meters per second, or 0.5 meters per second.

The present invention should not be considered limited to the particular examples described herein, but rather should be understood to cover all aspects of the invention as fairly set out in the attached claims. Various modifications, equivalent processes, as well as numerous structures to which the present invention can be applicable will be readily apparent to those of skill in the art to which the present invention is directed upon review of the instant specification.

### EXAMPLES

### Materials

SR444 (pentaerythritol triacrylate) is available from Sartomer Co., West Chester, Pa.

SR 508 (dipropylene glycol diacrylate) is available from Sartomer Co., West Chester, Pa.

SR 351 (trimethylol propane triacrylate) is available from Sartomer Co., West Chester, Pa.

SR 386 (tris(2-hydroxyethyl)isocyanurate triacrylate) is available from Sartomer Co., West Chester, Pa.

A174 (3-(trimethoxysilyl)propyl methacrylate) is available from OSI Specialties, Friendly,

Ebecryl 8301 (hexafunctional urethane acrylate) is available from Radcure UCB Chemicals, Smyrna, Ga.

Ebecryl 8402 (difunctional urethane acrylate) is available from Radcure UCB Chemicals, Smyma, Ga.

Ethyl acetate is available from Aldrich Chemical Co., Milwaukee, Wis.

Irgacure 184 (photoinitiator) available from Ciba Specialties, Basel, Switzerland.

Epon 828 (aromatic epoxy) is available from Resolution Performance Products, Houston, Tex.

Tone 0201 (polyester polyol) is available from Dow Chemicals, Midland, Mich.

Erl-4221 (cycloaliphatic epoxy) is available from Dow Chemicals, Midland, Mich.

MEK (methyl ethyl ketone) is available from Aldrich Chemical Co., Milwaukee, Wis.

Tol (toluene) is available from Aldrich Chemical Co., Milwaukee, Wis.

UVI-6976 (photoinitiator) is available from Aceto Corporation, Lake Success, N.Y.

Darocur 1173 (photoinitiator) is available from Ciba Specialties, Basel, Switzerland.

Methods

Elongation to Crack

The objective of this tensile test is to determine at which strain the wear layer starts to crack and to measure the maximum elongation of the film assembly at which strain the film breaks. All tensile tests are carried out at room temperature using an Instron Model 55R1122 equipped with a load cell of 500N nominal capacity. Ten samples are tested, measuring 6 inches in length and 0.5 inches in width. Prior to the test, the thickness of each specimen is measured by taking the average of three individual measurements at different positions. The sample are placed in rubber-coated grips at a gage length of one inch and pulled with a constant crosshead speed of 0.5 inch/min until failure. The onset of wear layer cracking is visually determined by the appearance of vertical cracks in the topcoat (cracks may be made more visible by directing a light beam on the film at a 90-degree angle relative to the stretching direction of the film). In some instances, the stress-strain diagram can also confirmed the onset of cracking.

Taber Abrasion

Taber abrasion was done using a CS-10 wheel, 500 grams and measuring the % haze prior to Tabering and after Tabering for a specified number of cycles to obtain a change in % haze value after the specified amount of cycles. Specific materials used are: Sand Paper: Abraser Resurfacing Discs Cat. No. S-1 from Taber Industries, Wheels: Calibrase CS-10 from Taber Industries, Taber Machine: Taber Industries 5150 Abraser, Haze reading machine: BYK Gardner haze guard plus Cat. No. 4725.

### Example 1

A number of curable polyacrylate wear layer formulations are prepared and formed into samples as described above. Each formulation is shown below.

Formulation 1

In a round-bottomed flask were mixed 1195 grams Nalco 2327 silica sol, commercially available from Nalco Chemical Co. (an ammonium ion-stabilized dispersion having a pH of 9.3 of colloidal silica particles, 40 percent solids, with an average particle diameter of 20 nanometers); 118 grams N,N-dimethyl acrylamide, commercially available from Aldrich Chemical Co; 120 grams 3-(trimethoxysilyl)propyl methacrylate coupling agent (A174); and 761 grams pentaerythritol triacrylate (SR444.) The round-bottomed flask was subsequently mounted on the vacuum line of a Buchi R152 Rotavapor, commercially available from Buchi Laboratory AG, Flanil, Switzerland with the bath temperature set to 55° C. A refrigerated mixture of 50 percent deionized water/50 percent antifreeze, was recirculated through the cooling coils. Volatile components were removed at a reduced pressure of 25 Torr until the distillation rate was reduced to less than 5 drops per minute (approximately 2 hours). The resulting material (1464 grams) was a clear liquid dispersion of acrylated silica particles in a mixture of N,N-dimethyl acrylamide and pentaerythritol triacrylate monomers (a ceramer composition). The Carl Fisher analysis of this ceramer composition indicated that the residual water in the composition is less than 1.5 percent by weight relative to the total weight of the composition. To this mixture was added 1282 grams of isopropanol, 87 grams of water, 29 grams of Tinuvin 292, and 36 grams of Irgacure 184. The final composition has is ˜50% solids and is amber to hazy in appearance.

Formulation 2

SR444 (pentaerythritol triacrylate) and no nanoparticles, in 50% MEK and 2.5 phr Darocur 1173.

Formulation 3

60 grams of SR 351 (trimethylol propane triacrylate), 30 grams of SR 386 (tris(2-hydroxyethyl)isocyanurate triacrylate, and 80 grams of 20 nanometer silica surface modified with 8.2 grams of A174, in 50% MEK and 2.5 phr Darocur 1173.

Formulation 4

40 grams of SR 508 (dipropylene glycol diacrylate) and 80 grams of 20 nanometer silica surface modified with 8.2 grams of A174, in 50% MEK and 2.5 phr Darocur 1173.

Sample Preparation

Samples (10 micrometer dry thickness) were coated onto primed (with PVDC) PET (2 mil) using a #5 Meyer bar. Curing was carried out using a UV Processor using medium pressure mercury lamps at about 200 to 240 mJ/cm², 50 ft/min, using a RPC UV processor (RPC Industries, Plainfield, Ill.), normal/normal settings, nitrogen purge and then heated in a line dryer with two zones at 27 degrees Celsius and a third zone at 60 degrees Celsius (each zone is 3 meters long.)

Each sample and an uncoated control sample of PET were tested for Taber Abrasion. The results (% haze change) are shown in Table 1.

TABLE 1

| | Taber | Taber | Taber |
|---|---|---|---|
| | Abrasion | Abrasion | Abrasion |
| Formulation | 100 cycles | 300 cycles | 500 cycles |
| Uncoated film | 40 | >50 | >50 |
| 1 | 2 | 9 | 11 |
| 2 | 6 | 25 | 35 |
| 3 | 3 | 8 | 11 |
| 4 | 2 | 6 | 7 |

### Example 2

A number of curable polyurethane acrylate wear layer formulations are prepared and formed into samples. Functionalized (surface modified) silica nanoparticles for this example can be formed by the following method:

5.1 grams (gm) of ammonium fluoride was dissolved in 20 gm water. A 12-liter resin flask was equipped with a reflux condenser and mechanical stirring (pitched turbine blade on the end of a stainless steel shaft). It was then charged with 4000 gm of Nalco 1042 silica sol (20 nm particles, 34.7% w/w silica; 1388 gm silica), 3600 gm ethyl acetate, 346 gm methacryloyloxypropyl(trimethoxy)silane, 400 gm more ethyl acetate (used to rinse the silane addition flask into the reaction flask). The aqueous ammonium fluoride solution was added to the reaction flask and stirring immediately started. An additional 20 gm water was used to rinse the ammonium fluoride addition flask into the reaction flask. The reaction was heated with a heating mantle. Roughly 5-10 minutes past ammonium fluoride addition, the reaction mixture began to form a gel, then white solids. After 20 minutes, there was a freely stirring white mixture in the reaction flask. The reaction was stirred at reflux for 20 hours, then ambiently cooled for 2 hours. 1000 gm sodium chloride was added and the mixture stirred for 45 minutes. Stirring halted, phases allowed to separate. The ethyl acetate phase was collected, dried with magnesium sulfate, then filtered to give 3975 gm of 29.0% w/w functionalized silica in ethyl acetate (% solids determined by oven drying at 150 degrees Celsius, for an hour). This ethyl acetate dispersion had a bluish opalescence.

Each formulation (grams of each component) is shown in Table 2 below.

TABLE 2

| | Formulation | | | | | | | | | |
|---|---|---|---|---|---|---|---|---|---|---|
| | 5 | 6 | 7 | 8 | 9 | 10 | 11 | 12 | 13 | 14 |
| 8301 | 4.2 | 0 | 2.9 | 0 | 1.5 | 0.8 | 0.8 | 1.5 | 1.9 | 1.7 |
| 8402 | 0 | 1.9 | 0.8 | 4.2 | 1.5 | 2.9 | 1.7 | 1.5 | 0 | 0.8 |
| Particles | 1.6 | 9.4 | 3.5 | 1.6 | 5.5 | 3.5 | 7.5 | 5.5 | 9.4 | 7.4 |
| EA | 4.2 | 0 | 2.8 | 4.2 | 1.5 | 2.8 | 0 | 1.5 | 0 | 0.1 |
| Irgacure | 0.2 | 0.2 | 0.2 | 0.2 | 0.2 | 0.2 | 0.2 | 0.2 | 0.2 | 0.2 |

8301 refers to Ebecryl 8301
8402 refers to Ebecryl 8402
Particles refer to Functionalized (Surface Modified) Silica Nanoparticles described above
EA refers to Ethyl acetate
Irgacure refers to Irgacure 184

Sample Preparation

Samples (10 micrometer dry thickness) were coated onto primed (with PVDC) PET (2 mil) using a #5 Meyer bar (R. D. Specialties, Webster, N.Y.) Curing was carried out using a UV Processor using medium pressure mercury lamps at about 200 to 240 mJ/cm², 50 ft/min, using a RPC UV processor (RPC Industries, Plainfield, Ill.), normal/normal settings, nitrogen purge.

Each sample was tested for Taber Abrasion (1000 cycles with a CS-10 wheel and 500 grams) and Elongation to Crack as described above. The results are shown in Table 3.

TABLE 3

| | Elongation to Crack | Taber Abrasion |
|---|---|---|
| Formulation | (%) | (% haze change) |
| 5 | 2.8 | 12.45 |
| 6 | 19.8 | 23.59 |
| 7 | 3.6 | 10.98 |
| 8 | 79.0 | 35.85 |
| 9 | 17.0 | 12.66 |
| 10 | 40.6 | 28.58 |
| 11 | 2.4 | 12.24 |
| 12 | 10.0 | 13.57 |
| 13 | ND | 12.92 |
| 14 | 2.0 | 11.27 |

ND = test not done

### Example 3

A number of curable epoxy wear layer formulations are prepared and formed into samples as described above. A general procedure for forming the epoxy/nanoparticle formulations follows.

A first set of formulations were formed as follow. An aqueous solution of nanosilica sol (from Nalco Chemical) was placed in a Pyrex beaker and under medium agitation, pre-washed Amberlite IR-120 plus ion exchange resin was slowly added until the pH measured between 2-3 (using colorpHast® PH paper). After stirring for 30 minutes at room temperature, the solution was filtered through a 10 micrometer nylon spectramesh sheet to remove the ion exchange resin and solids were determined. 250 grams of the ion exchanged nanosilica solution was placed in a round bottom flask and under medium agitation 75 grams of 1-methoxy-2-propanol were added followed by the quick addition of enough aqueous ammonium hydroxide to bring the pH to between 9-9.5. To this was then added a premixed solution of 425 g rams of 1-methoxy-2-propanol and enough trimethoxyphenylsilane to fully cover the surface.

Nalco 2327 (20 nm silica) is charged at 0.62 mmoles silane/gram of dry silica

Nalco 2329 (75 nm silica) is charged at 0.15 mmoles silane/gram of dry silica

Nalco TX11005 (110-123 nm silica) is charged at 0.1-0.09 mmoles silica/gram of dry silica

The resulting non-agglomerated solution was heated at 90-95° C. for approximately 22 hours then poured into pans and air dried to a white free flowing solid. The treated silica was dispersed in acetone (20-25% solids) using a high shear Silverson L4R mixer set at ¾ speed for 2 minutes. The resulting dispersion was covered and allowed to sit for a minimum of two hours, at which point it was filtered through a 10 micrometer nylon spectramesh sheet (from Spectrum) and % silica solids determined.

The following formulations were made up using the Nalco 2327 (20 nm) treated silica/acetone containing solution:

70% silica solids in ERL-4221E/Tone 0201 90/10 (Formulation 22)

70% silica solids in ERL-4221E/Tone 0201 80/20 (Formulation 25)

60% silica solids in ERL-4221E/Tone 0201 90/10 (Formulation 23)

60% silica solids in ERL-4221E/Tone 0201 80/20 (Formulation 26)

50% silica solids in ERL-4221E/Tone 0201 90/10 (Formulation 24)

50% silica solids in ERL-4221E/Tone 0201 80/20 (Formulations 27, 28)

The following formulation was made up using the Nalco 2329 treated silica/acetone containing solution:

50% silica solids in Epon 828/Tone 0201 80/20 (Formulation 18)

The following formulations were made up using the Nalco TXl 1005 (110-123 nm) treated silica/acetone containing solution:

50% silica solids in Epon 828/Tone 0201 80/20 (Formulation 16)

60% silica solids in ERL-4221E/Tone 0201 80/20 (Formulation 21)

A second set of formulations were formed as follows. 250 grams of an aqueous solution of Nalco TX10693 (47-50 nm nanosilica sol from Nalco Chemical) was placed in a round bottom flask and under medium agitation a premix of 500 grams of 1-methoxy-2-propanol, 2.31 grams of trimethoxyphenylsilane (Aldrich) and 2.88 grams of 2-(3,4-epoxycyclohexyl)ethyltrimethoxysilane (Gelest) was added over five minutes. The resulting non-agglomerated solution was heated at 90-95° C. for approximately 22 hours then poured into pans and air dried to a white free flowing solid. The treated silica was dispersed in acetone (20-25% solids) using a high shear Silverson L4R mixer set at ¾ speed for 2 minutes. The resulting dispersion was covered and allowed to sit for a minimum of two hours, at which point it was filtered through a 10 micrometer nylon spectramesh sheet (from Spectrum) and % silica solids determined. The following formulation was made up using this Nalco TX10693 (47-50 nm) treated silica/acetone containing solution:

50% silica solids in ERL-4221E/Tone 201 80/20 (formulation 19)

A third set of formulations were formed as follows. 250 grams of an aqueous solution of TX10693 (50 nm nanosilica sol from Nalco Chemical) was placed in a round bottom flask and under medium agitation a premix of 500 grams of 1-methoxy-2-propanol and 4.51 grams of trimethoxyphenylsilane was added over five minutes.

The resulting non-agglomerated solution was heated at 90-95° C. for approximately 22 hours then poured into pans and air dried to a white free flowing solid. The treated silica was dispersed in acetone (20-25% solids) using a high shear Silverson L4R mixer set at ¾ speed for 2 minutes. The resulting dispersion was covered and allowed to sit for a minimum of two hours, at which point it was filtered through a 10 micrometer nylon spectramesh sheet (from Spectrum) and % silica solids determined. The following formulation was made up using this Nalco TX10693 (47-50 nm) treated silica/acetone containing solution:

50% silica solids in ERL-4221E/Tone 0201 80/20 (Formulation 20)

50% silica solids in Epon 828/Tone 0201 80/20 (Formulation 17)

All percentages and ratios indicated are by weight.

The appropriate amount of the silica/acetone solution was added to the above resin formulations 15-28, mixed well and vacuumed stripped 80° C. using a Buchi rotary evaporator with a water aspirator followed by a final strip at 120° C. for 30 minutes (using a vacuum pump). After cooling to room temperature, UVI-6976 thermal/cationic catalyst was added (2% of the 50/50) catalyst/propylene carbonate solution Cbased on organic portion of formulation only) and mixed for 5 minutes at 3000 rpms using a FlakTek DAC 150 FVZ speed mixer.

A summary of each formulation is shown below.

Formulation 15

80/20 Epon 828/Tone 0201 and 25% MEK/Tol and no nanoparticles.

Formulation 16

80/20 Epon 828/Tone 0201 and 25% MEK/Tol and 50% loading of 123 nanometer silica nanoparticles.

Formulation 17

80/20 Epon 828/Tone 0201 and 25% MEK/Tol and 50% loading of 47 nanometer silica nanoparticles.

Formulation 18

80/20 Epon 828/Tone 0201 and 25% MEK/Tol and 50% loading of 75 nanometer silica nanoparticles.

Formulation 19

80/20 ERL 4221E/Tone 0201 and 25% MEK/Tol and 50% loading of 50 nanometer silica nanoparticles.

Formulation 20

80/20 ERL 4221E/Tone 0201 and 25% MEK/Tol and 50% loading of 50 nanometer silica nanoparticles.

Formulation 21

80/20 Epon 828/Tone 0201 and 25% MEK/Tol and 60% loading of 123 nanometer silica nanoparticles.

Formulation 22

90/10 ERL 4221E/Tone 0201 and 30% MEK/Tol and 70% loading of 20 nanometer silica nanoparticles.

Formulation 23

90/10 ERL 4221E/Tone 0201 and 25% MEK/Tol and 60% loading of 20 nanometer silica nanoparticles.

Formulation 24

90/10 ERL 4221E/Tone 0201 and 20% MEK/Tol and 50% loading of 20 nanometer silica nanoparticles.

Formulation 25

80/20 ERL 4221E/Tone 0201 and 40% MEK/Tol and 70% loading of 20 nanometer silica nanoparticles.

Formulation 26

80/20 ERL 4221E/Tone 0201 and 35% MEK/Tol and 60% loading of 20 nanometer silica nanoparticles.

Formulation 27

80/20 ERL 4221E/Tone 0201 and 25% MEK/Tol and 50% loading of 20 nanometer silica nanoparticles.

Formulation 28

80/20 ERL 4221E/Tone 0201 and 20% MEK/Tol and 50% loading of 20 nanometer silica nanoparticles.

Epoxy Wear layer Coating Procedure

A Meyer bar is an effective and simple method to coat thin films from solution. A mixture of MEK/Toluene (1:1) was used to dilute the described epoxy nano-particle solutions to approximately 75% solids content. The solutions were mixed to achieve complete D dissolution. Approximately 2 ml of each solution and a #9 Meyer bar was used to coat a thin film of approximately 10 micrometers thickness on PET films measuring 6 by 8 inches. The coated films were dried in an 80 degree Celsius oven for 10 minutes followed by U.V. curing (Fusion Systems) using a D-bulb (dose varied from 1.5 to 1.7 J/cm², depending on the formulation). The coated PET films were post-cured for additional 10 minutes in a 100 degree Celsius oven.

Formulation 15-21 wear layer samples were then tested for Taber Abrasion (CS-10 Wheel, 500 grams, 50 cycles). The results (% haze change) are shown in Table 4.

| | Taber Abrasion |
|---|---|
| Formulation | (% haze change) |
| 15 | 44 |
| 16 | 20 |
| 17 | 16 |
| 18 | 17 |
| 19 | 12 |
| 20 | 14 |
| 21 | 26 |

Formulation 22-28 wear layer sample were tested for Taber Abrasion (CS-10 Wheel, 500 grams, 500 cycles, 750 cycles, and 1000 cycles). The results (% haze change) are shown in Table 5.

TABLE 5

| | Taber Abrasion | Taber Abrasion | Taber Abrasion |
|---|---|---|---|
| Formulation | 500 cycles | 750 cycles | 1000 cycles |
| 22 | 5 | 7 | 8 |
| 23 | 6 | 9 | 10 |
| 24 | 8 | 11 | 12 |
| 25 | 7 | 9 | 10 |
| 26 | 7 | 10 | 10 |
| 27 | 9 | 15 | 23 |
| 28 | 8 | 11 | 15 |

1. A protective floor film comprising:
abase film layer; and
a U.V. cured wear layer disposed on the base film layer, the wear layer having a thickness in a range of 2 to 25 micrometers.

2. A protective floor film according to claim 1, wherein the U.V. cured wear layer comprises a plurality of surface modified inorganic particles.

3. A protective floor film according to claim 1, wherein the U.V. cured wear layer comprises a plurality of surface modified inorganic particles having a mean diameter in a range from 1 to 200 nanometers.

4. A protective floor film according to claim 1, wherein the U.V. cured wear layer comprises a plurality of surface modified inorganic particles having a mean diameter in a range from 5 to 150 nanometers.

5. A protective floor film according to claim 1, wherein the U.V. cared wear layer comprises a plurality of surface modified inorganic particles having a mean diameter in a range from 5 to 125 nanometers.

6. A protective floor film according to claim 1, wherein the U.V. cured wear layer comprises a plurality of surface modified inorganic particles having a mean diameter in a range from 5 to 150 nanometers, the surface modified inorganic particles comprising silica, alumina, or zirconia.

7. (canceled)

8. A protective floor film according to claim 1, wherein the wear layer comprises:
100 parts of a U.V. cured wear layer resin; and
to 200 parts of surface modified inorganic particles having a mean diameter in a range from 5 to 150 nanometers.

9. A protective floor film according to claim 1, wherein the U.V. cured wear layer comprises a polyacrylate.

10. (canceled)

11. A protective floor film according to claim 1, wherein the U.V. cured wear layer comprises a polyurethane acrylate.

12. (canceled)

13. A protective floor film according to claim 1, wherein the U.V. cured wear layer comprises an epoxy.

14. A protective floor film according to claim 1, wherein the U.V. cured wear layer comprises an epoxy and a polyol.

15. A protective floor film according to claim 1, wherein the U.V. cured wear layer comprises an epoxy and a polyester polyol.

16. A protective floor film according to claim 1, wherein the U.V. cured wear layer comprises an epoxy and a plurality of surface modified inorganic particles having a mean diameter in a range from 1 to 200 nanometers.

17. A protective floor film according to claim 1, wherein the U.V. cured wear layer has an elongation to crack value of greater than 2%.

18.-19. (canceled)

20. A protective floor film according to claim 1, wherein the U.V. cured wear layer has a Taber Abrasion Haze % change value at 1000 cycles of 50% or less.

21.-22. (canceled)

23. A protective floor film according to claim 1, wherein the U.V. cured wear layer has a thickness in a range of 2 to 15 micrometers.

24.-26. (canceled)

27. A protective floor film according to claim 1, further comprising a surface treatment layer disposed between the base substrate and the U.V. cured wear layer.

28. A protective floor film according to claim 1, wherein the base film layer has a thickness in a range of 25 to 250 micrometers.

29.-30. (canceled)

31. A protective floor film according to claim 1, wherein the base film layer comprises a thermoplastic polymer.

32.-33. (canceled)

34. A protective floor film according to claim 1, further comprising a pressure sensitive adhesive layer disposed the base film layer, wherein the base film layer is disposed between the pressure sensitive adhesive layer and the U.V. cured wear layer.

35. A method of making protective floor film comprising steps of:
coating a curable wear layer resin on a base film layer; and
curing the wear layer resin to form a cured wear layer having a thickness in a range of 2 to 25 micrometers.

36. A method according to claim 35, further comprising a step of:
disposing a surface treatment layer on the base film layer prior or to the coating step.

37. A method according to claim 35, further comprising a step of:
disposing a pressure sensitive adhesive layer on the base film layer, wherein the base film layer is disposed between the pressure sensitive adhesive layer and the cured wear layer.

38. A method according to claim 37, further comprising a step of:
disposing a release liner on the pressure sensitive adhesive layer, wherein the pressure sensitive adhesive layer is disposed between the base film layer and the release liner.

39. A method according to claim 37, wherein the coating step comprises coating a curable wear layer resin, comprising a plurality of surface modified inorganic particles having a mean diameter in a range from 5 to 200 nanometers, on a base film layer.

40.-77. (canceled)
